(19) United States
(12) Patent Application Publication
(10) Pub. No.: US 2006/0125272 A1
(43) Pub. Date: Jun. 15, 2006

(54) Seat rail assembly capable of sensing weight

(76) Inventors: Wolf-Dietrich Bauer, Leinfelden-Echterdingen (DE); Peter Ebel, Steinkirchen (DE); Martin Lanzerath, Esslingen (DE); Harald Rudolf, Tubingen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/528,011

(22) PCT Filed: Sep. 6, 2003
(86) PCT No.: PCT/EP03/09917

§ 371 Date: Dec. 30, 2005

(30) Foreign Application Priority Data
Sep. 17, 2002 (DE) 102-43-036.5

(51) Int. Cl. B60N 2/005

(52) U.S. Cl. 296/63

(57) ABSTRACT

A device for determining the seat weight on a vehicle seat assembly, provided with at least one seat rail on which the seat is mounted, and with a weight sensor that interacts with the seat rail. The at least one seat rail is fastened to the vehicle in a fixed manner via the weight sensor and at least one additional fastening device. The seat rail (2) is embedded inside an elastomer structure (5) that serves as a vibration damper while also acting as a step protection and overload protection.

This application claims priority to International Patent Application No. PCT/EP2003/009917, filed Sep. 6, 2003, designating the United States of America, and German Application DE 102 43 036.5, filed Sep. 17, 2002, the disclosure(s) of which is (are) expressly incorporated by reference herein.

### BACKGROUND AND SUMMARY OF THE INVENTION

The invention relates to a device for determining the seat weight on a vehicle seat assembly, provided with at least one seat rail on which the seat is mounted, and with a weight sensor that interacts with the seat rail, the at least one seat rail being fastened to the vehicle in a fixed manner via the weight sensor and at least one additional fastening device.

In passenger vehicles, it is becoming increasingly necessary for the occupancy of a seat to be detected by sensors to enable the safety devices, an airbag, for example, to adapt to the particular application. In this regard it is important to be able to recognize whether the occupant of the seat is a larger person or, for example, a small child in a child seat. In addition, regulatory specifications require, in particular for the passenger side, increasingly accurate detection of the type of seat occupancy.

To this end, various measurement principles are in use. One measurement principle is based on the concept of detecting the type of seat occupancy using sensors, such as OC films or bladder films, for example, introduced in the seat area, which selectively record the load. One advantage of this film system is that it has no effect on the attachment of the seat to the vehicle body, and therefore no structural changes must be made in this region. These films are positioned beneath the seat area in such a way that seat comfort is not impaired. However, this results in a lower resolution of the measurement area, thereby making it more difficult to unambiguously identify the type of seat occupancy.

An improved resolution of the measurement area can be achieved by directly determining the weight, as disclosed in the category-defining German reference DE 10053917 A1, for example. The disclosed seat weight measuring device has a seat frame with seat rails which is supported by three points. These points are situated on both front ends of the seat rail and on a weight sensor on the rear end of the seat frame.

When the weight sensor is a support point for the frame, the resolution of measurement values necessary for optimal recognition of seat occupancy is impaired when the measurement accuracy is limited by safety requirements for strength in case of an accident.

Furthermore, there is the problem that the measuring device may be affected by vibrations or outside loads, for example, by a person located behind the seat resting his/her feet.

The object of the present invention is to provide a high-resolution measuring device for determining the seat occupancy which is only minimally impaired by collision safety requirements.

To achieve this object, a generic device for determining the seat weight is proposed in which the at least one seat rail is embedded inside an elastomer structure mounted on the vehicle in a fixed manner.

The elastomer structure secures the seat rail under loads in the direction of travel or transverse to the direction of travel. Embedding the seat rail also prevents the seat rail from rotating under heavy load in a pivoting motion about the rail mounting device on the measurement sensor. The embodiment as an elastomer structure also results in damping of vibrations, which improves the measurement accuracy.

The elastomer structure is advantageously situated in the rear end region, relative to the direction of travel, of the at least one seat rail, the elastomer structure in one particularly beneficial refinement having a fixed end at least in the region of the at least one seat rail, on the back side and top side thereof. This arrangement protects the seat rail from influences, such as persons or objects located behind the seat, which could falsify the measurement results of the weight sensor as the result of pressure on the elastomer structure and, thus, on the seat rail.

In this regard it is practical to situate the elastomer structure in a housing, which itself is fixed and which advantageously can also be mounted on the vehicle body in a fixed manner, without impairing the desired vibration-damping resiliency of the elastomer structure. The housing is a substantially rigid enclosure for the elastomer which, however, has an opening that allows the seat rail to be passed through the housing to engage with the elastomer structure.

According to the invention it is also advantageous that the weight sensor is mounted on a weight receiver attached to the vehicle in a fixed manner, thereby securing the seat rail in its position.

It is further advantageous to mount the weight receiver and the housing which accommodates the elastomer structure, on opposite sides of a beam running transverse to the direction of travel, and to secure both to the beam in a fixed manner.

In one embodiment, the weight sensor is at least one bending beam situated between the parts of a two-part weight receiver, whereby the weight of the occupied or unoccupied seat assembly is relayed via the two-part receiver to the vehicle body, and the measurement accuracy of the weight sensor designed as a bending beam is not impaired by its attachment to the receiver or to the vehicle body.

Further advantages and features of the invention are provided in the following description of the exemplary embodiment illustrated in the drawings.

### BRIEF DESCRIPTION OF THE DRAWINGS

FIG. 1 is a seat rail assembly in a cutaway illustration of the side view,

FIG. 2 shows a top view of the seat rail assembly in FIG. 1, in a partial cutaway illustration.

### DETAILED DESCRIPTION OF THE DRAWINGS

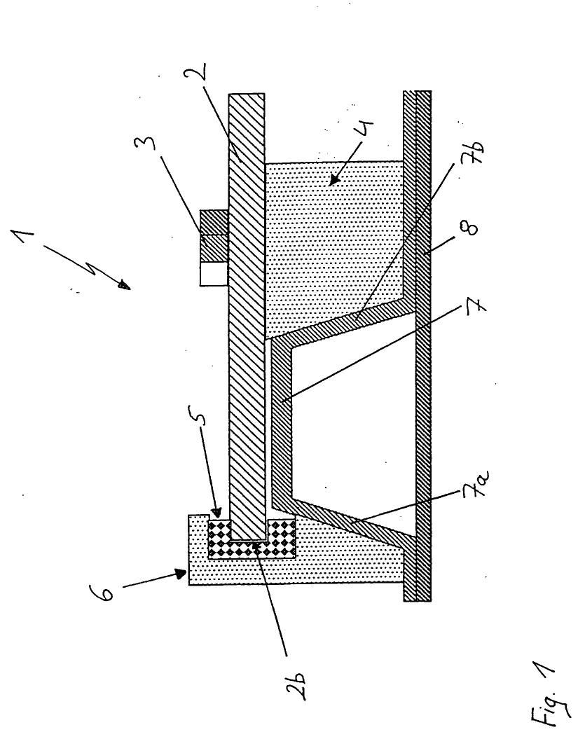

The seat rail assembly 1 shown in FIG. 1 is suitable, for example, for mounting in particular a passenger seat in a passenger motor vehicle.

The seat rail assembly 1 has a seat rail 2 on which a seat, not shown, is generally moveably mounted. The seat rail 2, in principle, has a cuboidal design and extends principally in the direction of travel, and thus in the direction of the longitudinal axis of the passenger motor vehicle (not shown).

To install the seat rail 2 to the vehicle in a fixed manner, the seat rail is mounted in its front and rear areas (each relative to the longitudinal direction of the vehicle). In an accident, these positions of the mountings prevent excessive lifting forces which would cause the seat situated on the seat rail 2 to exert stress on the seat rail mountings.

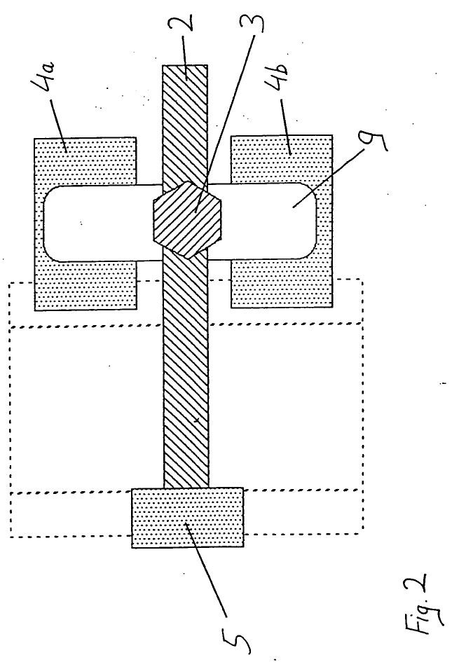

In its front region, the seat rail 2 is securely attached by a mounting 3 to a weight receiver 4, which, in turn, has a weight sensor, to be described in detail below with reference to FIG. 2.

In the region of its rear end, the seat rail 2 is mounted in an elastomer structure 5. The seat rail 2 is embedded in the elastomer structure 5 in such a way that the latter contacts the rear end face 2b of the seat rail 2 and at least partially overlaps the top and bottom sides of same. The elastomer structure 5 is a cuboidal, elastic block having a central blind hole which dimensionally corresponds to the cross section of the seat rail 2, so that the seat rail 2 may be inserted flush into the elastomer structure 5. Vibrations occurring in the seat rail 2, which may be caused by driving, for example, are damped by the elastomer structure 5.

The seat rail 2 is mounted on the vehicle body only via the weight receiver 4 and the elastomer structure 5. A second fixed, immovable mounting in addition to the arrangement on the weight receiver 4 containing the weight sensor would considerably influence the measurement results at the sensor, since a significant portion of the force acting on the seat rail 2 could be absorbed by a fixed mounting.

The elastomer structure 5 is elastically resilient and allows the seat rail 2 to incline slightly before bending occurs.

The overlapping of the top side of the seat rail 2 by the elastomer structure 5 prevents a lifting motion of the seat rail 2 about the fixed mounting 3 in the event of a vehicle collision.

The elastomer structure 5 is situated in a rigid housing 6. This housing 6 functions not only to position the elastomer structure, but also to protect against effects from the rear on the seat rail 2, which could influence the measurement results from the weight sensor. One such effect, for example, could be from a person sitting in the back seat of the motor vehicle resting his/her feet behind the seat rail. Such an action could result in detection of a weight on the seat that is not, in front, present, at least to such an extent, and thus to an inappropriate assignment of the type of seat occupancy.

The housing 6 and the weight receiver 4 are each connected on two sides to a crossmember 7 having a trapezoidal cross-sectional area which extends transversely with respect to the seat rail. The crossmember 7 itself is securely mounted on a vehicle body 8.

The housing 6 and weight receiver 4 are situated on the longitudinal sides 7a and 7b of the crossmember 7 in such a way that they are able to absorb at least a portion of the forces arising in the direction of travel, particularly in the case of an accident.

The seat rail 2 is not directly attached to the crossmember 7, but, rather, is mounted only to the weight receiver 4 and, via the elastomer structure 5, to the housing 6.

As shown in FIG. 2, this type of seat rail assembly improves the measurement accuracy during weight determination without detracting from collision safety. FIG. 2 shows in the top view the two-part weight receiver 4, whose individual parts 4a and 4b are separated from one another. A bending element 9 is mounted in a fixed manner on parts 4a and 4b, spanning the distance between the parts.

The seat rail 2 is centrally guided between the two parts 4a and 4b, and is connected in a fixed manner via the mounting 3 to the bending element 9 as a weight sensor.

A weight load on the seat rail 2 results in bending of the bending element 9 between the two weight receiver elements 4a and 4b. The degree of bending may be determined by means of a strain gauge, for example, enabling determination as to the weight load on the seat rail 2.

The type and strength of the attachment of the bending element 9 does not impair its measurement accuracy. Quite the contrary, a rigid, immovable attachment of a bending element to the bearing points results in increased measurement accuracy.

The weight force thus determined is used in a control device, not shown, to make conclusions as to the type of seat occupancy and to appropriately deploy an airbag associated with this seat.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A device for determining weight of a seat on a vehicle seat assembly, comprising
at least one seat rail on which the seat is mounted;
a weight sensor that interacts with the seat rail, wherein the at least one seat rail is fastened to the vehicle in a fixed manner by the weight sensor and by at least one additional fastening device, and wherein the at least one additional fastening device is an elastomer structure mounted in a fixed manner to the vehicle; and
at least one seat rail embedded in said elastomer structure.

2. The device according to claim 1, wherein the elastomer structure is situated in a rear end region, relative to the direction of travel, of the at least one seat rails.

3. The device according to claim 2, wherein the elastomer structure has a fixed end at least in a region of the at least one seat rail, on a back side and a top side thereof.

4. The device according to claim 1, wherein the elastomer structure is situated in a housing which has an opening in a direction of travel.

5. The device according to claim 4, wherein the housing is attached to the vehicle in a fixed manner.

6. The device according to claim 1, wherein the weight sensor is mounted on a weight receiver which is attached to the vehicle in a fixed manner.

7. The device according to claim 6, wherein the weight receiver and the housing which accommodates the elastomer structure are mounted on opposite sides of a crossmember running transverse to the direction of travel.

8. The device according to claim 7, wherein the weight sensor is at least one bending element situated between a two-part weight receiver.

9. The device according to claim 2, wherein the elastomer structure is situated in a housing which has an opening in a direction of travel.

10. The device according to claim 3, wherein the elastomer structure is situated in a housing which has an opening in a direction of travel.

11. The device according to claim 2, wherein the weight sensor is mounted on a weight receiver which is attached to the vehicle in a fixed manner.

12. The device according to claim 3, wherein the weight sensor is mounted on a weight receiver which is attached to the vehicle in a fixed manner.

13. The device according to claim 4, wherein the weight sensor is mounted on a weight receiver which is attached to the vehicle in a fixed manner.

14. The device according to claim 5, wherein the weight sensor is mounted on a weight receiver which is attached to the vehicle in a fixed manner.

15. A device for determining weight on a seat, comprising:
a weight sensor;
an elastomer structure;
a seat rail supported by said weight sensor and embedded in said elastomer structure wherein said seat is mounted on said seat rail.

16. The device according to claim 15, wherein the elastomer structure is situated in a rear end region, relative to the direction of travel, of the at least one seat rail.

17. The device according to claim 16, wherein the elastomer structure has a fixed end at least in a region of the at least one seat rail, on a back side and a top side thereof.

18. The device according to claim 15, wherein the elastomer structure is situated in a housing which has an opening in a direction of travel.

19. The device according to claim 18, wherein the housing is attached to the vehicle in a fixed manner.
